(19) United States
(12) Patent Application Publication
(10) Pub. No.: US 2005/0213297 A1
(43) Pub. Date: Sep. 29, 2005

(54) Extended peripheral battery pack for a tablet computer

(75) Inventors: Imran Ulla, Austin, TX (US); Mark Rylander, Austin, TX (US)

Correspondence Address: FORTKORT GRETHER + KELTON LLP, 8911 N. CAPITAL OF TEXAS HWY., SUITE 3200, AUSTIN, TX, 78759, US

(73) Assignee: Motion Computing, Inc.

(21) Appl. No.: 11/121,222

(22) Filed: May 3, 2005

Related U.S. Application Data
(63) Continuation-in-part of application No. 10/691,035, filed on Oct. 22, 2003.
(60) Provisional application No. 60/667,954, filed on Apr. 4, 2005.

(51) Int. Cl. G06F 1/16

(52) U.S. Cl. 361/683

(57) ABSTRACT

A device is provided which comprises an ultra thin extended battery pack (301). A incorporating a functional peripheral device (321) such as a DVD player, card reader, receiver and/or transmitter, or extended memory.

### RELATED APPLICATIONS

This application is a continuation-in-part of application Ser. No. 10/691,035 filed on Oct. 22, 2003 entitled External Peripheral Battery Pack for a Tablet PC; and claims priority to the U.S. provisional patent application Ser. No. 60/667,954 filed on Apr. 4, 2005 entitled External Peripheral Battery Pack For a Tablet PC.

### TECHNICAL FIELD OF THE INVENTION

The present invention pertains generally to modular tablet computer systems, and more particularly to extended battery packs and other peripherals for such systems.

### BACKGROUND OF THE INVENTION

Personal computers have recently become very popular for a variety of uses ranging from home, office, engineering, sales, marketing, and military applications. Virtually every aspect of business, engineering and science utilizes some form of computer system on a daily basis. Since their introduction, personal computers have become increasingly compact while simultaneously becoming increasingly powerful. This progression of smaller and more powerful personal computers has reached the point that some personal computer manufacturers are providing a tablet personal computer, or “tablet PC.”

The tablet PC is a fully functional personal computer, which may include a Microsoft Windows® operating system or other such operating systems as are known to the art. The tablet PC not only is capable of running familiar productivity applications such as Microsoft's WORD®, EXCEL® and POWERPOINT®, but also offers the same rich connectivity to the Internet that a desktop or notebook PC provides. The tablet PC may run these programs directly from a hard drive installed in the tablet PC or it may run the programs through a network with minimal localized storage of programs and data. These latter systems are commonly referred to as thin clients. The thin client may require a network connection either by physical or wireless data communication connections. In addition, the tablet PC adds the simplicity of pen and paper, because the user can write on the screen for data input.

As tablet PCs have become increasingly popular, users have come to expect these systems to have all of the features of bulkier desktop models. Consequently, the power demands made on the battery packs for these systems have increased significantly. On the other hand, portability is a key feature for tablet PCs. Hence, the battery packs made for these systems must provide several hours of use between charging. In bulkier laptop PCs, extended battery life can be achieved by providing additional battery packs. However, this is a difficult solution to implement in tablet PCs, since there is little additional space in the chassis of such systems to accommodate additional battery packs. The situation is complicated by the fact that the battery packs must be readily accessible so that they can be removed for recharging, if necessary, or so that depleted packs can be readily replaced with recharged units.

There is a need for modular peripheral devices that also supplies more power to maintain or increase the operating time of a tablet PC when driving the additional peripheral device.

There is thus a need in the art for a battery pack suitable for use in tablet PCs that does not add significantly to the bulk of the tablet PC, that provides additional battery life, and that is easy to replace or recharge. These and other needs are met by the devices and methodologies disclosed herein and hereinafter described.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 illustrates a perspective view of the interior of a tablet PC cover/battery pack combination with the battery pack removed from the cover;

FIG. 2 illustrates a perspective view of the exterior of a tablet PC cover/battery pack combination with the battery pack removed from the cover;

FIG. 3 illustrates a perspective view of the exterior of a tablet PC cover/battery pack combination (disposed in a closed position on the PC);

FIG. 4 illustrates a perspective view of the exterior of a tablet PC cover/battery pack combination;

FIG. 5 illustrates a rear view of a tablet PC cover/battery pack combination disposed on a tablet PC;

FIG. 6 illustrates a perspective view of a tablet PC cover/battery pack combination illustrating how the combination couples to the tablet PC;

FIG. 7 illustrates a perspective view of a tablet PC and a tablet PC cover/battery pack combination with the battery pack removed from the cover;

FIG. 8 illustrates a perspective view of a tablet PC cover/battery pack combination illustrating how the combination couples to the tablet PC;

FIG. 9 illustrates a perspective view of a tablet PC cover/battery pack combination illustrating how the combination couples to the tablet PC;

FIG. 10 illustrates a perspective view of the exterior of a tablet PC cover/battery pack combination in which the battery pack is integral with the PC cover;

FIG. 11 illustrates a perspective view of another embodiment of the present invention showing incorporation of a peripheral device in the extended battery pack;

FIG. 12 is a perspective view of the electrical contacts of the embodiment of an extended battery pack illustrated in FIG. 11.

FIG. 13 illustrates a top view of an alternative embodiment of an extended battery pack;

FIG. 14 illustrates a back view of the embodiment of an extended battery pack of illustrated in FIG. 13;

FIG. 15 illustrates a side view of the embodiment illustrated in FIG. 13;

FIG. 16 illustrates an embodiment of a tablet personal computer configured to accept the extended battery pack illustrated in FIG. 13.

FIG. 17 illustrates a side view of the extended battery pack illustrated in FIG. 13 mounted on the tablet personal computer illustrated in FIG. 16;

FIG. 18 illustrates a top view of the extended battery/tablet PC combination illustrated in FIG. 17;

FIG. 19 illustrates a view of an improved dock for a tablet personal computer;

FIG. 20 illustrates a tablet PC extended battery combination illustrated in FIG. 17 mounted in the improved dock illustrated in FIG. 19; and

FIG. 21 illustrates the combination illustrated in FIG. 20 without the extended battery pack.

### DETAILED DESCRIPTION OF THE INVENTION

It has now been found that the aforementioned needs can be met by providing a tablet PC with a protective cover that houses one or more battery packs. These battery packs may be in addition to, or in lieu of, any battery packs that may be housed in the chassis of the PC. Since the protective cover must have a relatively large surface area in order to protect the display, and since battery packs can be made relatively thin, the battery packs can be disposed in bays created in the exterior surface of the protective cover without adding significantly to the bulk of the cover or the tablet PC as a whole.

Moreover, since the battery packs are disposed on an external surface of the cover, they are readily accessible, and can be easily removed or replaced. Also, since the battery packs are disposed on an external surface, they can be provided with LED lights or other such means that indicate the status of the battery. In addition, the PC can be constructed such that the battery packs are disposed on a bottom surface of the PC so that the battery packs are visible only when the tablet PC is being transported, thereby maximizing the aesthetic features of the device.

It has also been found that additional needs can be meet with the addition of a second type of peripheral in addition to the battery in the cover/battery pack combination.

It has also been found that the peripheral needs of a tablet cam be meet with a thin form battery pack with a second peripheral device installed. It has also been found that the extended battery needs of a tablet PC can be meet with an ultra thin battery that covers most of the back of a tablet PC thus enabling the option of a thinner tablet with the extended battery pack mounted on the Tablet and an even thinner Tablet without the extended battery pack mounted on the back of the Tablet allowing the user more options on how much to take mobile with her.

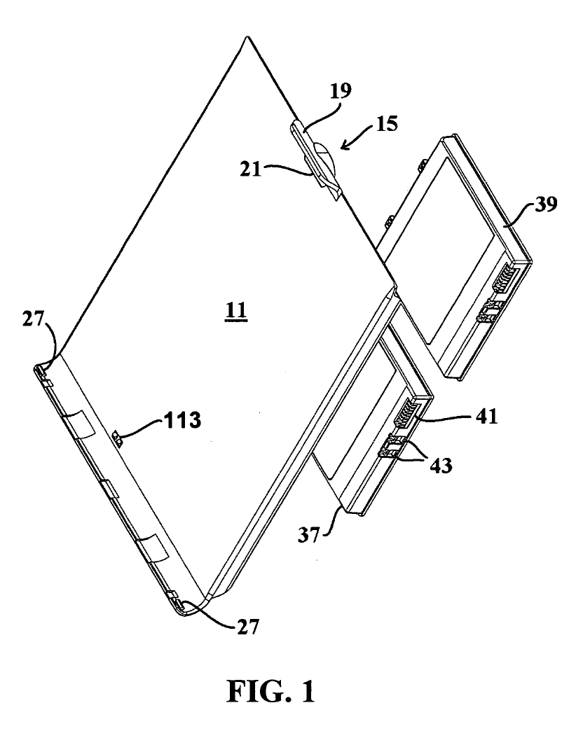

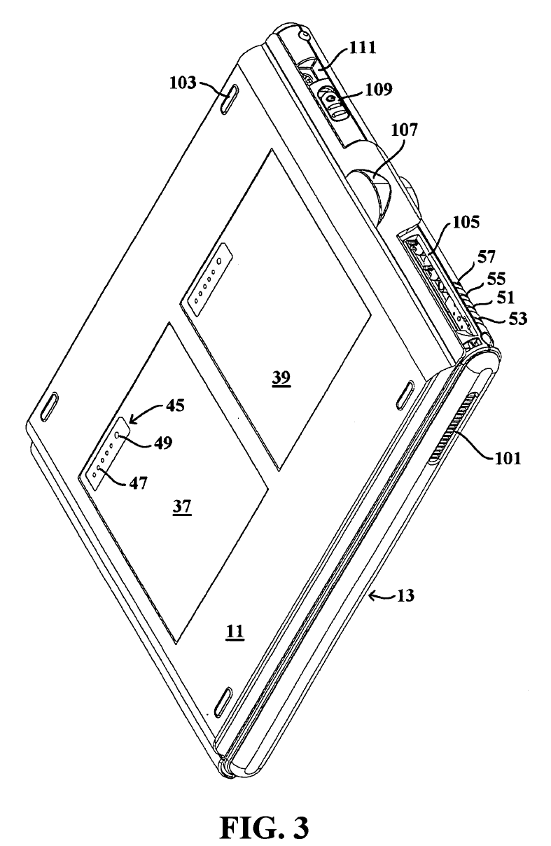

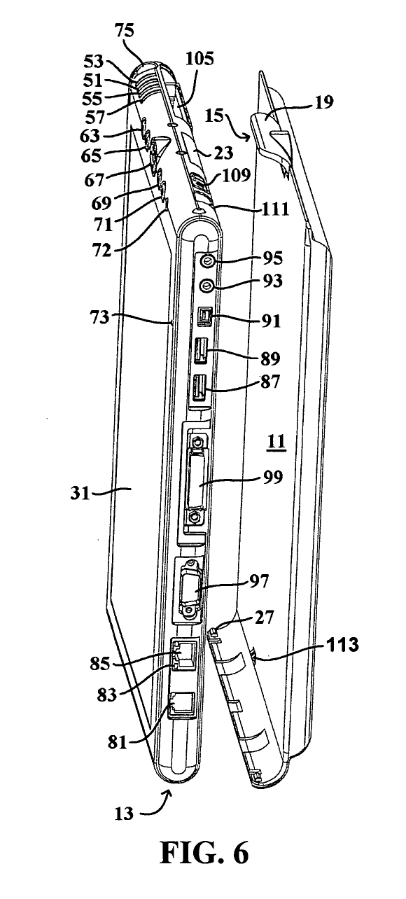

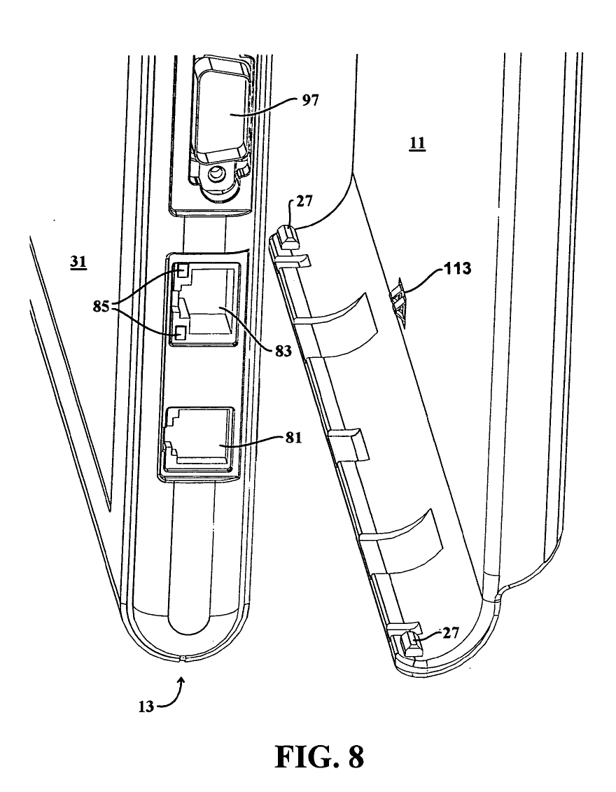

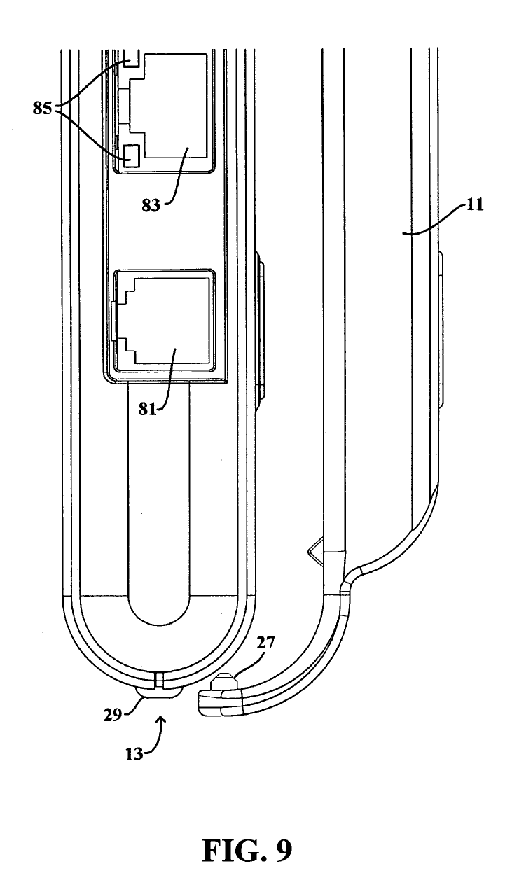

The preferred embodiments of the devices and methodologies described herein will now be illustrated with reference to FIG. 1 through FIG. 21, with like numerals being used to refer to like and corresponding parts of the various drawings. As seen therein, a cover 11 for a tablet PC 13 (see FIG. 3 and FIG. 5 through FIG. 9) is provided. The cover has a latch 15 (see FIG. 1 and FIG. 5 through FIG. 7) on a first end which comprises a wall 19 with a protrusion 21 thereon, and which engages a receptacle 23 (see FIG. 6) in the chassis of the PC. The opposing or second end of the cover has a plurality of protrusions 27 (see FIG. 1 and FIG. 5 through FIG. 9) thereon that likewise engage a lip 29 (see FIG. 9) disposed on the chassis of the PC. The latch 15 and protrusions 27 serve to secure the cover to the PC when the PC is not in use in such a way that the display 31 (see FIG. 6 through FIG. 8) of the PC is covered and protected.

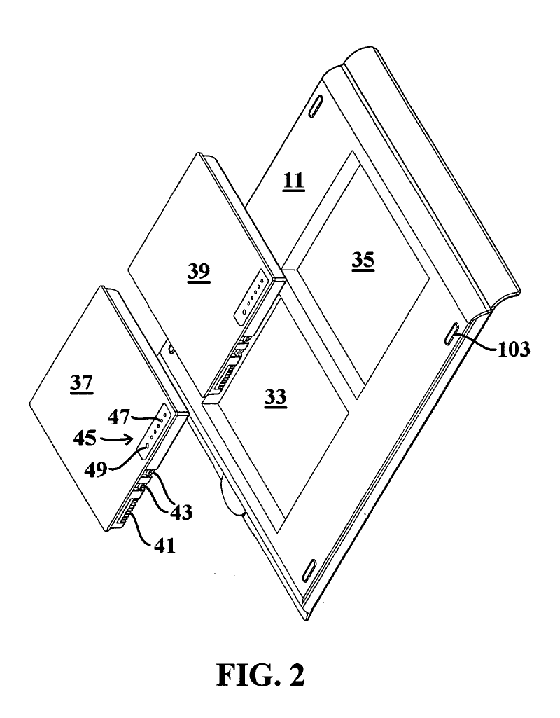

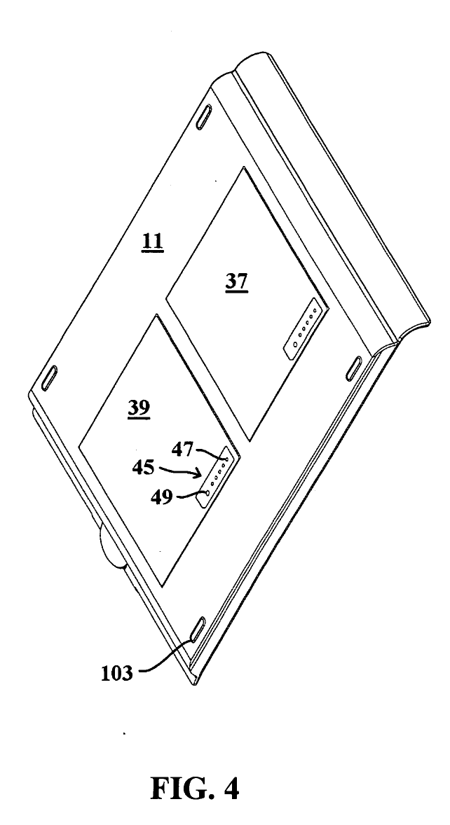

As best seen in FIG. 2 through FIG. 4, the protective cover 11 is provided with first 33 and second 35 bays (see FIG. 2) that house first 37 and second 39 battery packs (see FIG. 3 and FIG. 4), respectively. It will be understood, of course, that various embodiments are possible, including those in which the cover houses only a single battery pack, and those in which the cover houses more than two battery packs. Moreover, the battery packs may consist of a single battery or multiple batteries, and may also contain various other elements, such as protective coverings or circuitry, as are commonly employed in battery packs.

The bays are preferably constructed such that they releasably engage the battery packs such that the battery packs are held securely in the bays during use, but can be readily removed from the bays using only a normal amount of manual pressure when it is necessary to replace or recharge them. This may be accomplished, for example, through the use of protrusions or resilient members on the battery packs which releasably engage the surfaces of the bays.

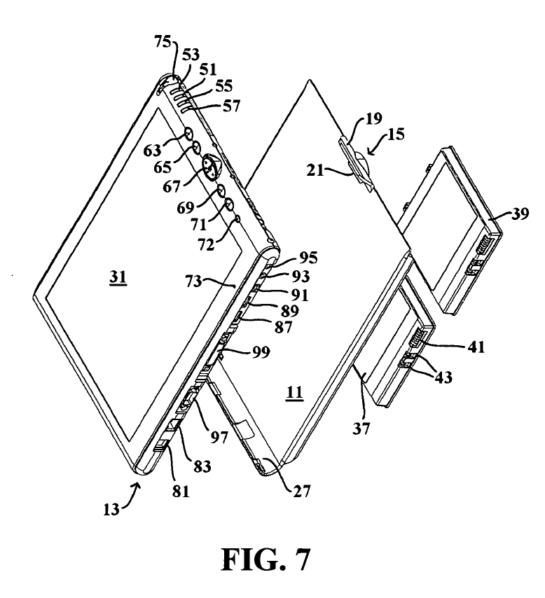

Each of the battery packs is equipped with electrical connectors 41, 43 (see FIG. 2 and FIG. 7) that are adapted to releasably connect the anode(s) and cathode(s) of the battery pack to the internal circuitry of the PC. Each battery pack is also provided with an indicator 45 (see FIG. 2 through FIG. 4) on its external surface which indicates the status of the battery. In the particular embodiment depicted, the indicator includes a five-LED battery gauge 47. The gauge 47 can be activated by pushing the activation button 49 next to the LEDs. It will be appreciated, however, that various other types of indicators may be employed to give a reading on battery status.

In addition to any indicators present on the battery packs, the tablet PC may also be equipped with means for indicating the status of the battery packs, either singly or collectively, in a manner that will alert the user to the status while the PC is in use. Such means may include audio visual and/or a physical indications.

In the particular embodiment depicted in FIG. 7, the surface of the PC adjacent to the display is provided with a battery indicator light 51 (see FIG. 6 and FIG. 7) that indicate when the battery is fully charged, when the battery is charging, when the battery is overheated or defective, when the battery is discharging abnormally, and/or when the battery is approaching depletion (e.g., less than 10% charged). The battery indicator lights may also flash, emit a steady glow, emit certain colors, or use combinations of the foregoing to indicate battery or charging status. In the particular embodiment depicted, a power LED 53 is provided which indicates when the PC is connected to a power source, a hard disk drive (HDD) indicator 55 is provided which indicates the status of the hard disk drive, and a wireless network indicator 57 is provided which indicates the status of the connection of the PC to a wireless network.

Computers incorporating the protective covers and battery packs described herein may have various features as are known to the art, and the covers may be designed to allow convenient use of, or access to, these features, while at the same time protecting the PC from harm. In the particular embodiment illustrated in FIG. 7, these features include a liquid crystal display 31, which may include protective layers made out of acrylic or other such materials that provide a hard writing surface, minimize glare, and improve viewability; an escape key 63; a function key 65; a 5-way directional control button 67; first 69 and second 71 hot keys; a security key 72; an external microphone 73; and a pen holder 75.

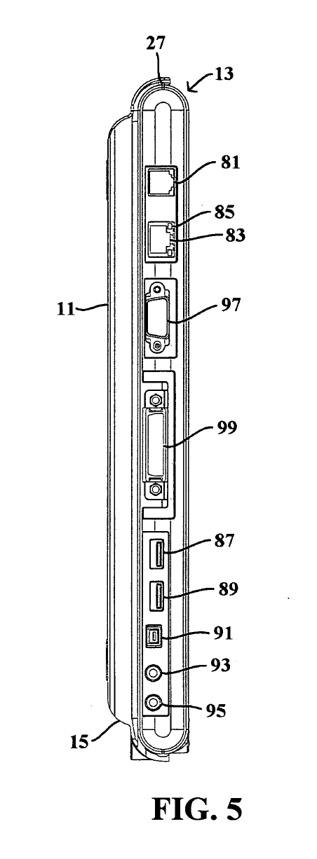

As shown in FIG. 5 through FIG. 7, the Tablet may further include an RJ-11 port 81 that supports a standard telephone cord jack; an RJ-45 Ethernet LAN port 83 (shown in this embodiment with dual status LEDs 85) that facilitates connection of the PC to a network, cable modem, or xDSL; first 87 and second 89 USB connectors; an IEEE 1394 connector 91; an audio-in (microphone) jack 93; an audio-out (headphone) jack 95; a VGA monitor connector 97; and a flex-dock connector 99. With reference to FIG. 3, the PC is also provided with speakers 101 and non-skid pads 103. With reference to FIG. 5, the PC is further provided with a PCA card slot 105; an antenna 107; a power switch 109; and an AC power socket 111.

The protective cover can be made from various materials. For example, it may be constructed out of various metals or metals alloys. Magnesium alloys are especially preferable since they are lightweight, durable, and easy to maintain. The cover may also be fabricated or molded out of a variety of plastics.

Preferably, the cover is adapted to be releasably attached to the PC in a first orientation in which it protects the display, as when the PC is being transported or is not in use. It is also preferred that the cover is adapted to be attached to the PC in a second orientation in which it is connected to the bottom of the PC when the PC is in use, thus providing convenient storage for the cover. Moreover, the cover is provided with an electronic interface 113 such that, when the cover is in the second orientation, the battery pack is in electrical communication with the internal circuitry of the PC, thus allowing the battery pack to power the PC.

Various battery types may be utilized in the battery packs described herein. These batteries may be based on various chemistries, and may have one or more cells. Preferably, each battery pack comprises one or more lithium-ion batteries, and more preferably, each battery pack comprises a 6-cell lithium-ion battery. Fully charged, a battery pack of this type is capable of powering a tablet PC for over 4 hours, depending on conditions and use. Hence, in embodiments of the tablet PCs described herein which incorporate dual battery packs, the battery packs can provide over 8 hours of usage before recharging is necessary.

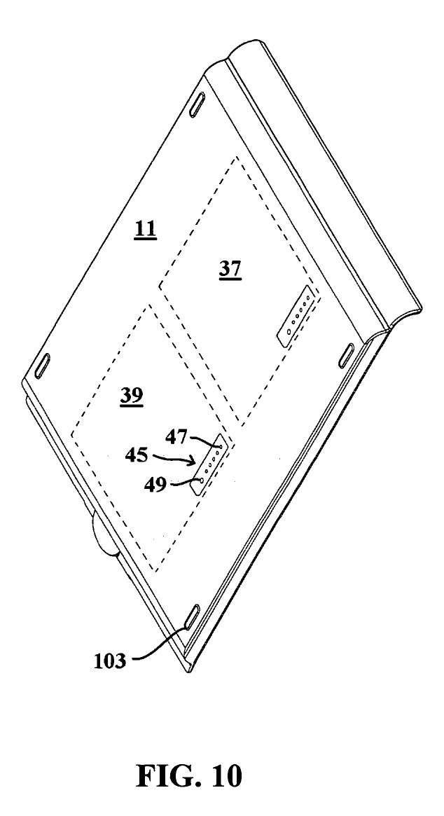

In many of the embodiments described herein, the battery packs are removable. However, it will be appreciated that embodiments of the PC cover/battery pack combinations may also be made in accordance with the teachings herein in which the battery packs form an integral part of the PC cover. One such embodiment is illustrated in FIG. 10, which shows with dashed lines one possible placement of the battery packs 37, 39 within the cover 11 (the profile of this embodiment would be similar to that shown in FIG. 9). In the particular embodiment depicted, each of the battery packs is provided with an external indicator 45 showing the charge status of the battery packs. However, it will be appreciated that the external indicators are not necessary, and that other means as described above could be provided for indicating battery charge status.

It is also to be noted that, while the battery packs may be designed to be removable so that they can be placed in an external battery charger and recharged, they may also be designed to be rechargeable in situ, or they may be designed for recharging in either manner. If the battery pack is designed to be rechargeable in situ, the PC cover, the PC itself, and/or the battery packs may be equipped with one or more suitable power input ports which are adapted to couple with an external battery charger or power source. The PC cover, the PC itself, and/or the battery packs may also be provided with appropriate circuitry to enable or facilitate recharging. Thus, for example, in some embodiments, the battery packs may be recharged simply by attaching a battery charger to the PC and then attaching the cover (in either orientation) to the PC.

The cover may also be adapted to serve as an auxiliary power source for charging the internal batteries of the PC. Since the cover is typically removed from the PC while the PC is in use, the cover can be attached to a wall outlet or other AC or DC external power source during PC usage. Later, when the PC is no longer being used, the cover can be removed from the external power source and attached to the PC, where it recharges the internal PC batteries. Thus, in embodiments of this type, the internal batteries of the PC can be recharged when the device is in storage or is otherwise idle. The battery packs in the cover may be of a type that recharge very rapidly upon connection to the external power source, and then provide a slower (and typically safer) recharge of the internal PC batteries.

In addition to serving as a power source for the PC, the cover may also be utilized as either a primary or auxiliary AC or DC power source for various peripheral devices, and may be provided with appropriate circuitry and couplings for this purpose. Thus, for example, the cover may be adapted to serve as a power source for external disk drives, such as RW CD or DVD drives, displays, printers, scanners, hubs, speakers, and the like. It may also be adapted to serve as a primary or auxiliary power source for various other devices, such as cell phones, PDAs (Personal Digital Assistants), audio or video digital recorders, cameras, or radios. The cover may be provided with various ports to enable the cover to be coupled to these devices, or it may be provided with a single port and various adapters for this same purpose.

FIG. 11 illustrates an alternative embodiment of the combined cover extended battery pack 200. In the embodiment shown the extended battery pack 200 includes a DVD read drive 202. In the embodiment shown the DVD is slot loading in order to get a small enough profile to fit in the extended battery pack and to ease use when the extended batter back is mounted on a Tablet PC.

In alternative embodiments other types of optical drives are installed in the extended battery pack. For example DVDRW or CDRW and DVDRWCDRW are available. In yet other embodiments of the extended battery pack other storage devices such as a hard drive or solid-state memory devices are installed with the battery cells.

In another embodiment of the extended battery special function electronics like a sound card or a global positioning system (GPS) receiver card, and/or a mobile phone transmitter/receiver. These special function electronics cards may provide additional or different input and output connections to the system.

In yet other embodiments the extended battery includes a magnetic and/or optical swipe card reader or a slot for installing a smart card and/or an identity card for the mobile phone transmitter/receiver; compact flash memory card readers (which are commonly used for cameras and other recording devices); and/or a PCMCIA card bus slot for receiving type 1 and/or type 2 PCMCIA cards.

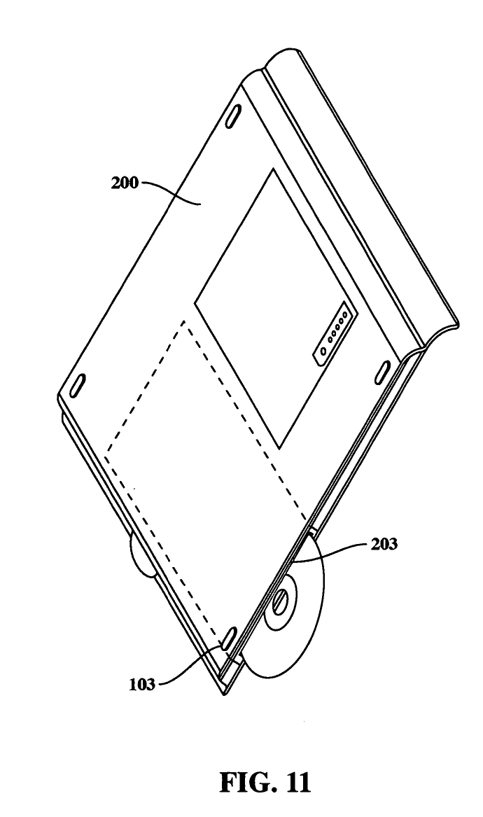

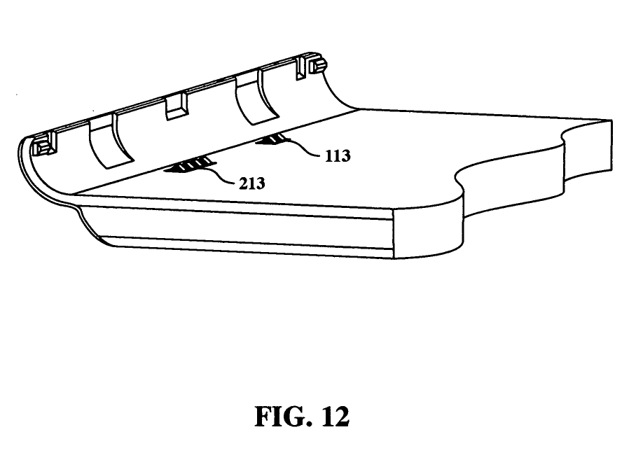

FIG. 12 illustrates the electrical connectors for the embodiment illustrated in FIG. 11. In addition to the power connections 113, these embodiments of the extended battery pack also include data communication contact connections 213. In the preferred embodiment, these connections meet a standard electrical communication protocols—for example USB or FireWire. However, it is not necessary that these connections meet the physical connector portions of the respective protocol standard.

FIG. 13 illustrates another embodiment of an extended battery pack 301. In particular this figure illustrates a top view said embodiment. This embodiment includes the main body 303 which is flat and thin and contains battery elements such as a lithium ion battery cells (other types of electrical power battery cells are also contemplated).

The embodiment shown includes a user interface 305 for the user to test the batter to determine the presence of a charge and preferably the relative level of the charge presence comprised of an activation button that activates a circuit to test the available charge and light a number of LED's indicative of said level of charge.

The battery pack 301 includes antiskid pads 307. For the purpose of mounting the device on a tablet PC, the illustrated embodiment of the extended battery pack includes registration tabs 311 and a spring loaded locking mechanism(s) 315. Since the batter pack is so thin the embodiment illustrated also includes lift tabs 317 proximate to the lock release tabs 319 of the locking mechanism(s) 315. In the embodiment shown the lift tabs 317 facilitate the dismounting/removal of the extended battery pack 301 from the tablet PC 339 by a user lifting with lift tabs 317 with their index fingers while engaging the lock release(s) 319 of the locking mechanism(s) with their thumbs.

The embodiment illustrated includes a DVD drive as indicated by the disk 321. In alternative embodiments other types of optical drives optical drives are installed in the extended battery pack. For example DVDRW or CDRW and DVDRWCDRW are available. In yet other embodiments of the extended battery pack include other storage devices such as a hard drive or solid-state memory devices.

In another embodiment of the extended battery special function electronics like a sound card or a global positioning system (GPS) receiver card, and/or a mobile phone transmitter/receiver. These special function electronics cards may provide additional or different input and output connections to the system.

In yet other embodiments the extended battery includes a magnetic and/or optical swipe card reader or a slot for installing a smart card and/or an identity card for the mobile phone transmitter/receiver; compact flash memory card readers which are commonly used for cameras and other recording devices; and/or a MCMCIA card bus slot for receiving either type 1 and/or type 2 PCMCIA cards.

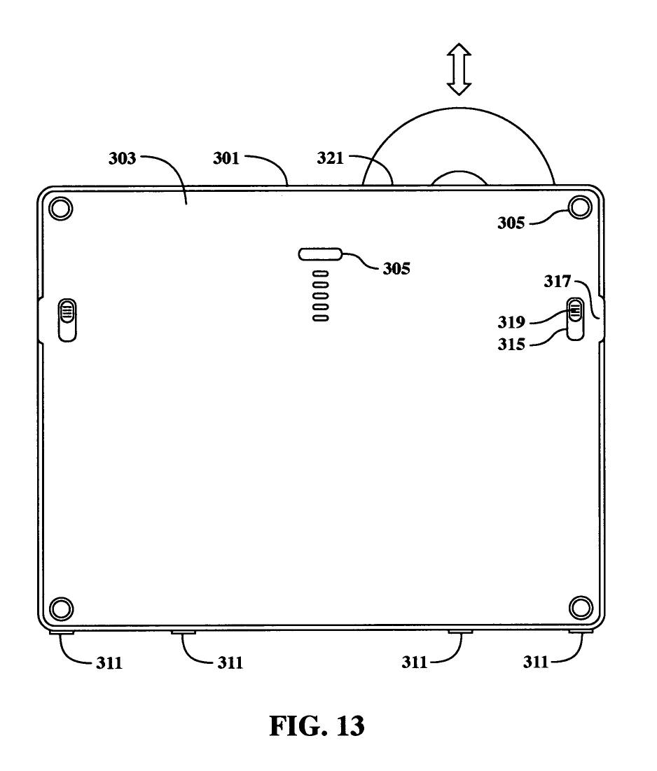

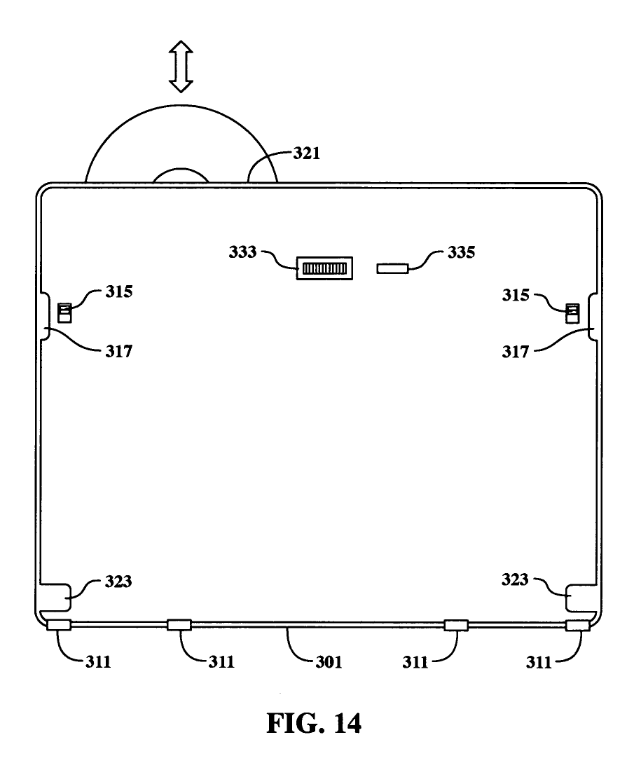

FIG. 14 illustrates a back view of the extended battery pack embodiment illustrated in FIG. 13. In this view the registration tabs 311 and locking mechanism(s) 315 and lift tabs 317 can be seen as well. In this view an indent(s) 323 to allow nesting over anti-skid pads on the bottom of the tablet PC can be seen. This view also shows the location of the power connector 333 of this embodiment of an extended battery pack. This connector 333 makes electrical power connections between the power components of the extended battery pack 301 and the tablet PC 339 of FIG. 16 as discussed in more detail below. In addition, since this embodiment of the extended battery pack includes a peripheral device, the extended battery pack includes additional electrical connections 335 for communication between the peripheral device and the tablet PC 339. In the preferred embodiment this communication link complies with the electrical and communication portions of a protocol such as USB or IEEE 1394 FireWire. However it may not meet physical connector portions of those standards. In an alternative embodiment only one connector providing both power and data connections is possible and may be preferred for easier registration during mounting.

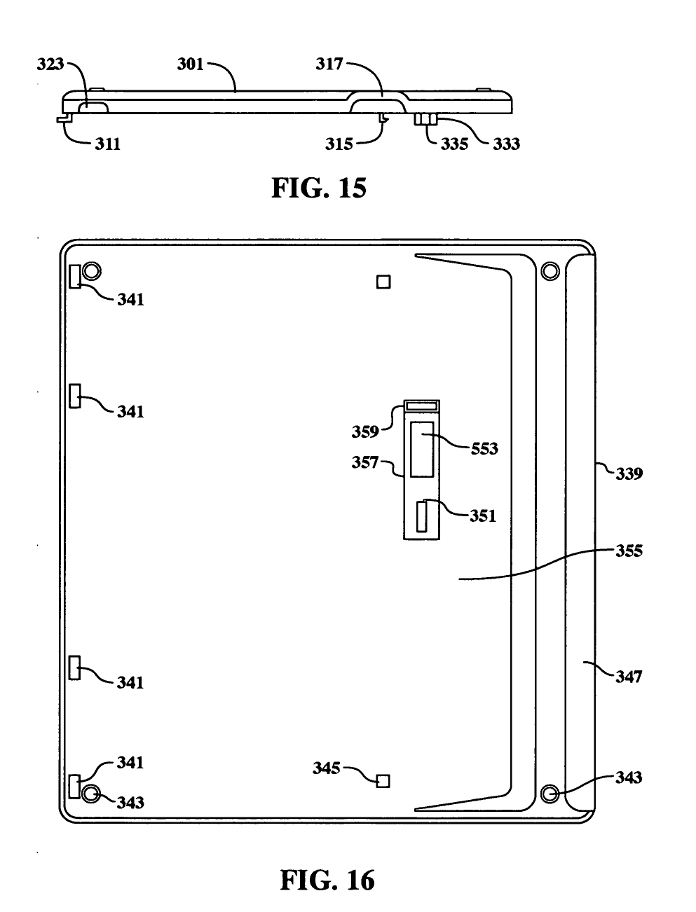

FIG. 15 illustrates a side edge view of the extended battery pack 301. From this view the sides of one registration tab 311 and one locking mechanism 315 and one lifting tab 317 can be seen. The side of the data connector 335 and part of the side of the power connector 333 can also be seen in this side view.

FIG. 16 illustrates the bottom side 335 of a tablet PC 339 which is configured to receive the extended battery pack of the type illustrated in FIG. 13. The tablet PC includes registration slots 341 for receiving registration tabs 311 and anti-skid pads 343 for preventing skidding of the tablet 339 when not used with the extended battery. The tablet PC 339 illustrated has a cylindrical main battery 347. In alternative embodiments the main battery may lie under the extended battery requiring that the extended battery be removed in order to replace the main battery.

FIG. 16 also illustrates the data 351 and power 353 connectors which mate with the corresponding connectors in the extended battery pack 301: 335 and 333 respectively. In the preferred embodiment, these connectors are recessed 357 inside the tablet PC 339 so that they do not extend out from the planar surface 355 of the bottom of the tablet PC 339. In the preferred embodiment the opening 357 in the bottom surface 355 of the tablet PC 339 has a door 359 that closes or can be closed when the extended battery pack is not in use. The illustrated embodiment employs a manual sliding door that in the figure sides up to open and slides down to close. In an alternative embodiment the door s a barn door that is forced open inwards as the extended battery pack 301 is mounted on the Tablet PC 339 and shuts automatically when the extended battery pack is removed.

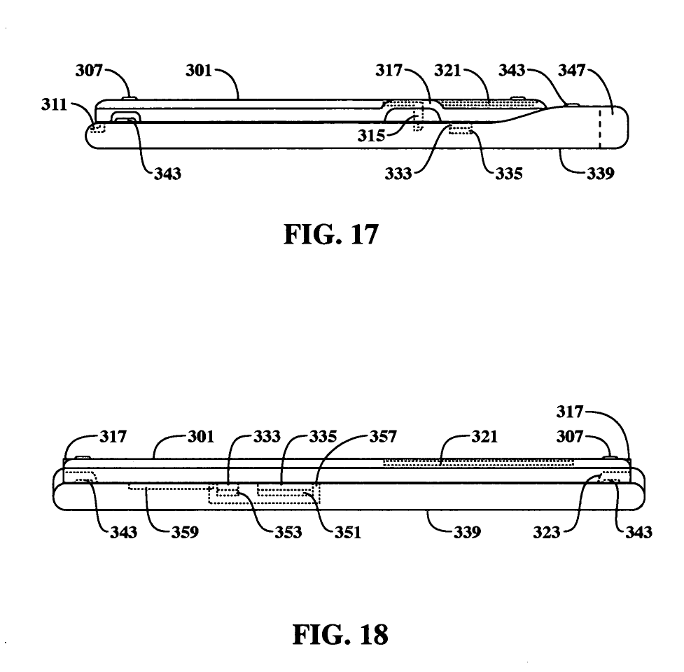

FIG. 17 is a side edge view of the extended battery 301 illustrated in FIG. 13 mounted on the tablet PC of FIG. 16 339 by means of the registration tabs 311 and the locking mechanism 315. The lifting tabs 317 can be seen proximate to the locking mechanisms 315. The cylindrical battery 347 is also outlined in FIG. 17. From this figure the combination of battery packs for the Tablet 339 provides the user with more options. The use of the elongated cylindrical main battery pack 347 allows for a much thinner tablet PC 17. The use of the ultra thin wide extended battery pack 301 that covers most of the back of the tablet PC 339 allows the addition of extended battery power but at the thickness of a conventional tablet PC. Additionally it allows the addition of peripheral devices 321 (a DVD player in the embodiment shown) without compromising the operating time allowed with available battery power.

FIG. 18 illustrates a bottom side edge view of the combined extended battery pack 301 and tablet PC 339. This figure illustrated the nesting of the skid pads 343 on the back of the tablet PC 339 in the recesses 323. It also shows the skid pads on the extended battery pack 301. The figure also illustrates the slot for receiving DVD or CD ROM disks 321. The tablets connector opening 357 and its respective door 359 are outlined as are the data connection between connectors 335 and 351 and the power connection between connectors 333 and 353 of the extended battery pack 301 and the tablet respectively.

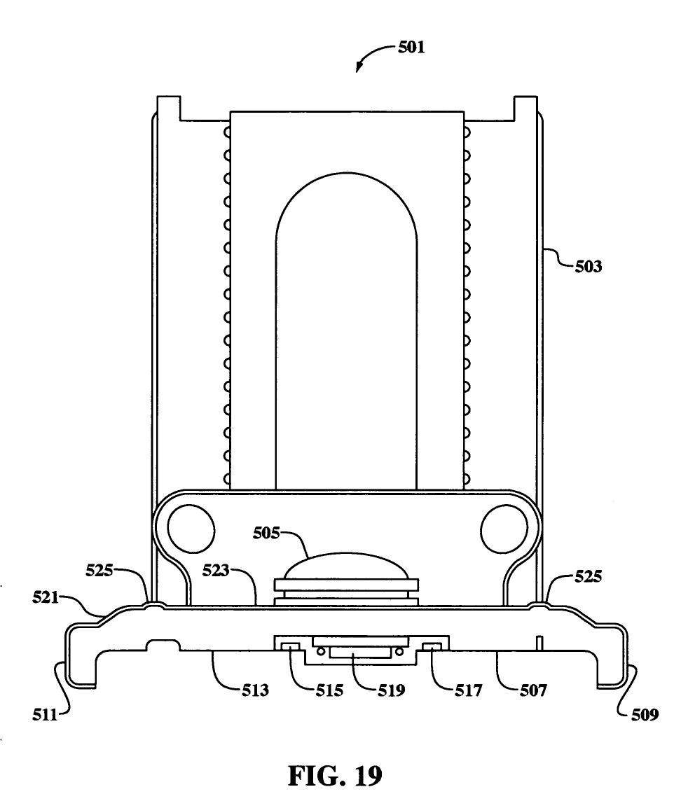

FIG. 19 is an illustration of an improved docking system 501 for the tablet PC configured to receive the extended battery pack illustrated in FIG. 13 through FIG. 18. The dock illustrated is modification of the embodiment of the docking system illustrated in U.S. Pat. No. 6,856,506, application Ser. No. 10/175,581, and U.S. Pat. No. ______ application Ser. No. 10/756,962 both issued to Doherty et al. and assigned to Motion Computing, Inc the specifications of which are fully incorporated herein by reference.

FIG. 19 illustrates a docking system 501 comprised of the base 503, an articulatable support member 505 and a cradle 507. In the embodiment shown the cradle includes two side supports 509 and 511 that provide two points of support and a web section 513 that connects the two side supports 509 and 511. The web section 513 include registration tabs 515 and 517 that line up with registration holes on the tablet and an electrical connector 519 for power and data connection to the base of the docking system. The back portion 521 of the web section 513 includes a recess portion 523 and smaller recessed sections 525.

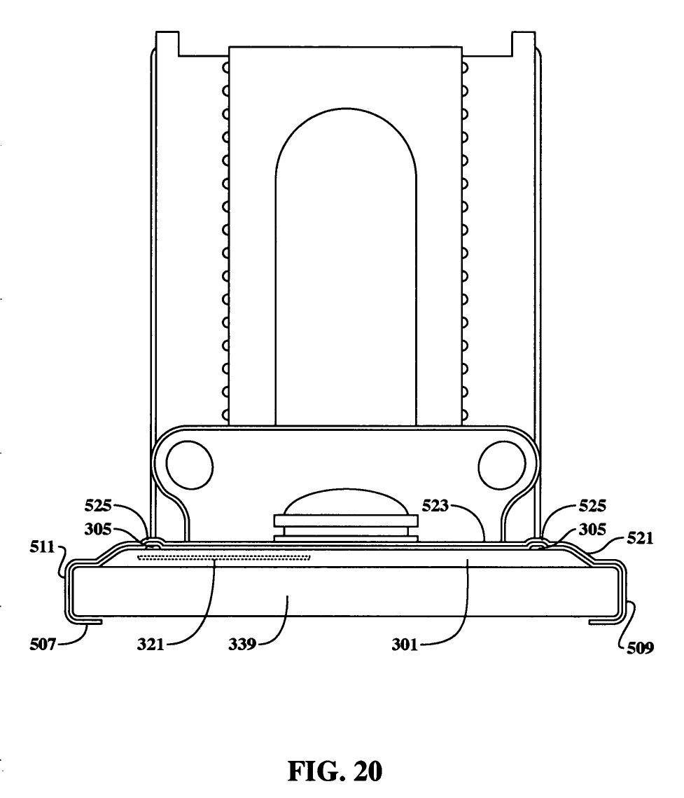

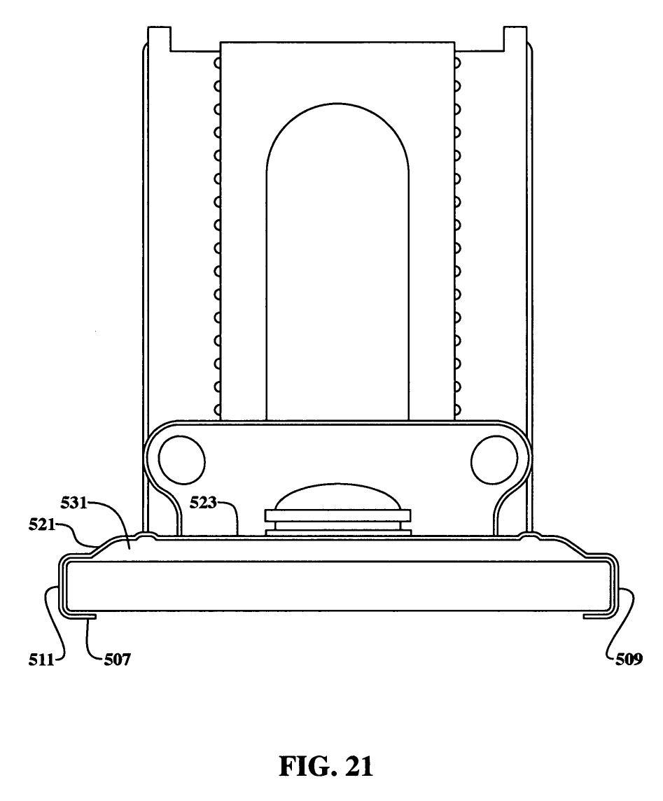

FIG. 20 illustrates an extended battery pack 301 mounted on a tablet PC 339 nested between the sides 509 and 511 of the cradle 507. FIG. 21 illustrates tablet PC 339 nested in the cradle 507 without an extended battery pack 301 mounted to it leaving the recesses space 531 created by recesses 523 and 525 empty. With said recess sections, the cradle 507 is capable of receiving the tablet computer 339 with and without the mounted extended battery pack.

In the preferred embodiments, the extended battery packs recharges with the main batteries of the Tablet PC while at the same time serving as a power source for the Tablet PC and any a peripheral device. For example, the cover may be adapted to recharge the internal batteries of the PC while at the same time providing a low voltage (e.g., 5V) power source for a cell phone.

Although the present invention is described in detail, it should be understood that various changes, substitutions and alterations can be made hereto without departing from the spirit and scope of the invention.

1. A device for providing power to a tablet computer with a display-side and a back-side comprising:
a housing containing:
a rechargeable battery, and
a peripheral device providing a functionality other than a source of power to the tablet computer;
electrical contacts for connecting the rechargeable battery to the power circuit of the tablet computer;
a data communication link for transferring data between the peripheral device and the tablet computer; and
mounting interface with which the device can affix to the back-side of the tablet computer.

2. The device of claim 1, wherein said mounting interface releasably affixes the device to the back-side of the tablet computer.

3. The device of claim 1, wherein said peripheral device is an optical drive and wherein the housing has an opening for receiving optical disks.

4. The device of claim 3, wherein said optical drive can read DVD formatted optical disks.

5. The device of claim 1 wherein the peripheral device includes a hard drive.

6. The device of claim 1 wherein the peripheral device includes a global positioning system receiver.

7. The device of claim 1 wherein the peripheral device includes a solid-state memory array.

8. The device of claim 1 wherein the peripheral device includes a mobile phone transmitter receiver.

9. The device of claim 8 wherein the housing includes an opening for receiving a mobile phone identity card.

10. The device of claim 1 wherein the peripheral device includes a card reader.

11. The device of claim 10 wherein the card reader reads smart cards.

12. The device of claim 10 wherein the card reader is a magnetic card reader.

13. The device of claim 10 wherein the card reader is a swipe magnetic card reader.

14. The device of claim 1 wherein the peripheral device is an optical code reader.

15. The device of claim 1, wherein said battery pack has an indicator thereon which indicates the degree to which the battery is charged.

16. The device of claim 1, wherein said peripheral device is a disk drive.

17. The device of claim 1, wherein said peripheral device includes is a cell phone receiver and transmitter.

18. The device of claim 1, wherein said computer has internal batteries, wherein said cover is adapted to be connected to an external power source and to thereby recharge the battery pack disposed in said cover, and wherein said cover is further adapted to recharge the internal batteries of the computer.

19. The device of claim 18, wherein the batteries in the device are recharged when the device is mounted on a tablet computer that is electrically connected to an external power source.
